(19) United States
(12) Patent Application Publication
(10) Pub. No.: US 2008/0150297 A1
(43) Pub. Date: Jun. 26, 2008

(54) System and method for generating electric power

(76) Inventor: Brett Shadwell, Monterey, CA (US)

Correspondence Address: JAMES RAY & ASSOCIATES, 2640 Pitcairn Road, Monroeville, PA, 15146, US

(21) Appl. No.: 12/004,884

(22) Filed: Dec. 20, 2007

Related U.S. Application Data
(60) Provisional application No. 60/870,974, filed on Dec. 20, 2006.

(51) Int. Cl. H02K 35/00; H02K 7/075

(52) U.S. Cl. 290/1 R; 310/20

(57) ABSTRACT

A system for generating electric power includes an electric generator capable of generating such electric power upon supply of a rotational motion and an elongated member supported by air spring actuators which are mounted within a motor vehicle roadway for generating a vertical motion. A crank assembly is provided and has a first end thereof secured to a protruding end of an input shaft of the electric generator and has an opposed second end thereof operably connected to the elongated member for converting the vertical motion into the rotational motion.

### CROSS-REFERENCE TO RELATED APPLICATIONS

This application is related to and claims priority from Provisional Patent Application Ser. No. 60/870,974 filed on Dec. 20, 2006.

### FIELD OF THE INVENTION

The present invention relates, in general, to electric power generation and, more particularly, this invention relates to a system and method for generating electric power by converting a vertical motion generated by an apparatus installed within a roadway into a rotational motion for operating an electric generator.

### BACKGROUND OF THE INVENTION

Prior to the conception and design of the present invention, efforts have been made to minimize or eliminate use of fossil fuels in order to generate electric power. Wind farms employing plurality of wind turbines have been uses to harvest the wind speed in order to generate, by a wind turbine, electric power without polluting the environment. However, wind farms are associated with a number of disadvantages. They are generally located at a significant distance from heavily populated areas requiring most of such generated electric power. The strength of the wind is never constant varying from zero to storm force. This condition results in that the wind turbines do not produce the same amount of electricity all the time. Wind turbines are noisy. Each one can generate the same level of noise as a family car traveling at 70 mph. Many see large wind turbines as unsightly and invasive structures that are not pleasant or interesting to look at.

Therefore, there is a continuing need for systems capable of generating electric power with significant reduction or elimination of using fossil fuels.

### SUMMARY OF THE INVENTION

The invention provides a system for generating electric power. The system includes an electric generator capable of generating an electric power upon supply of a rotational motion. There is means mounted within a motor vehicle roadway for generating a vertical motion. A crank means is provided and has a first end thereof secured to a protruding end of an input shaft of the electric generator and has an opposed second end thereof operably connected to the vertical motion generating means for converting the vertical motion into the rotational motion.

The present invention also provides a method of generating electric power. The method includes the step of providing means capable of generating reciprocal linear motion. Then, mounting the linear motion means below a roadway surface having motor vehicles traveling thereon so that the linear motion is generated in a vertical direction. Next, positioning an elongated member across and above at least a portion of the roadway surface. Securing the elongated member to at least the linear motion means. Then, positioning an electric generator in close proximity to the elongated member, the electric generator capable of generating an electric power upon supply of a rotational motion. Next, connecting, with a crank mechanism, the elongated member to the electric generator. Then, generating, with the crank mechanism, the rotational motion upon cyclical engagement and disengagement of motor vehicle wheels with the elongated member. Finally, generating, with the electric generator, the electric power upon supply of the rotational motion.

### OBJECTS OF THE INVENTION

It is, therefore, one of the primary objects of the present invention to provide a system for generating electric power.

Another object of the present invention is to provide a system for generating electric power that utilizes power from moving motor vehicles.

Yet another object of the present invention is to provide a system for generating electric power that minimizes or eliminates intrusion to natural surroundings.

A further object of the present invention is to provide a system for generating electric power that converts a vertical motion generated by an apparatus mounted across a roadway surface into a rotational motion for operating an electric generator.

Yet a further object of the present invention is to provide a system for generating electric power that is simple to use.

An additional object of the present invention is to provide a system for generating electric power that is relatively quite.

Another object of the present invention is to provide a method of generating electric power by employing an aforementioned system.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a planar schematic view of a system for generating electric power of the present invention;

FIG. 2 is a cross-sectional view of the system for generating electric power along lines 2-2 of FIG. 1, particularly illustrating the device capable of producing vertical motion upon pressure applied by the wheels of the motor vehicle;

FIG. 3 is a block diagram of the system of FIG. 1; and

FIG. 4 is a partial elevation view of the system for generating electric power along lines 3-3 of FIG. 1.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

The present invention overcomes disadvantages of the prior art systems by providing a system and method for generating electric power by converting a vertical motion produced by an apparatus mounted within a roadway surface into a rotational motion for operating an electric generator.

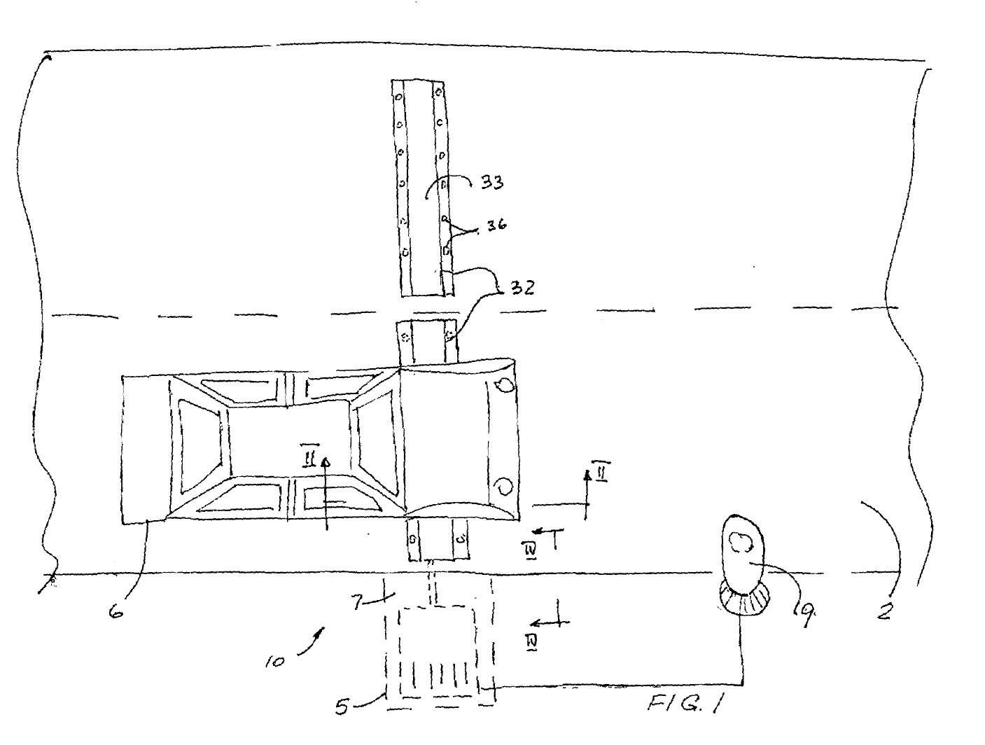

The best mode for carrying out the invention is presented in terms of its presently preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Reference is now made, to FIGS. 1-4, wherein there is shown a system, generally designated as 10, for generating electric power.

The system 10 includes an electric generator 20 capable of generating an electric power upon supply of a rotational motion. The electric generator 20 may be of any well known electromagnetic induction type employing an assembly of permanent magnets 24 that are connected to the shaft 22 and that surround the coil of wire 26. By way of an example only, such electric generator 20 may be of a type presently employed in wind turbines (not shown) and, therefore, the detail description thereof will be omitted for the sake of brevity.

There is means, generally designated as 30, which is mounted within a motor vehicle roadway 2 for generating a reciprocal linear motion in a vertical direction. In accordance with a presently preferred embodiment of the invention such vertical motion generating means 30 includes an elongated member 32 extending across at least a portion of the roadway 2 and across a direction of travel of motor vehicles 6. Preferably, an upper surface 33 of the elongated member 32 protrudes above a surface 4 of the roadway 2. In operation, the upper surface 33 of the elongated member 32 is engageable with wheels 8 of motor vehicles 6 traveling on such roadway surface 4.

There is also means, generally designated as 40, which is disposed below the roadway surface 4 and which is operably secured to the elongated member 32 for enabling such linear movement thereof in the vertical direction. More particularly, the vertical movement means 40 permit and dampen downward movement of the elongated member 32 upon force applied by the vehicle wheels 8 onto the upper surface 33. The vertical movement means 40 is also adapted for vertically and linearly returning the elongated member 32 to an original position upon disengagement of the motor vehicle wheels 8 therewith. In the presently preferred embodiment of the invention, such vertical movement means 40 includes at least one bias spring, preferably such as an air spring actuator 42. Although, it is within the scope of the present invention to employ conventional coiled springs and/or hydraulic dampers (not shown).

An elongated crank means 50, best shown in FIG. 4, is provided and has a first end 52 thereof secured to a protruding end 23 of an input shaft 22 of the electric generator 20 and has an opposed second end 54 thereof operably connected to the elongated member 32 for converting the vertical motion thereof into the rotational motion received by the electric generator 20.

Positioning of the system 10 and, particularly, mounting of the elongated member 32 and the vertical movement means 40 will depend on a specific application and is not intended to be a limiting factor of this application.

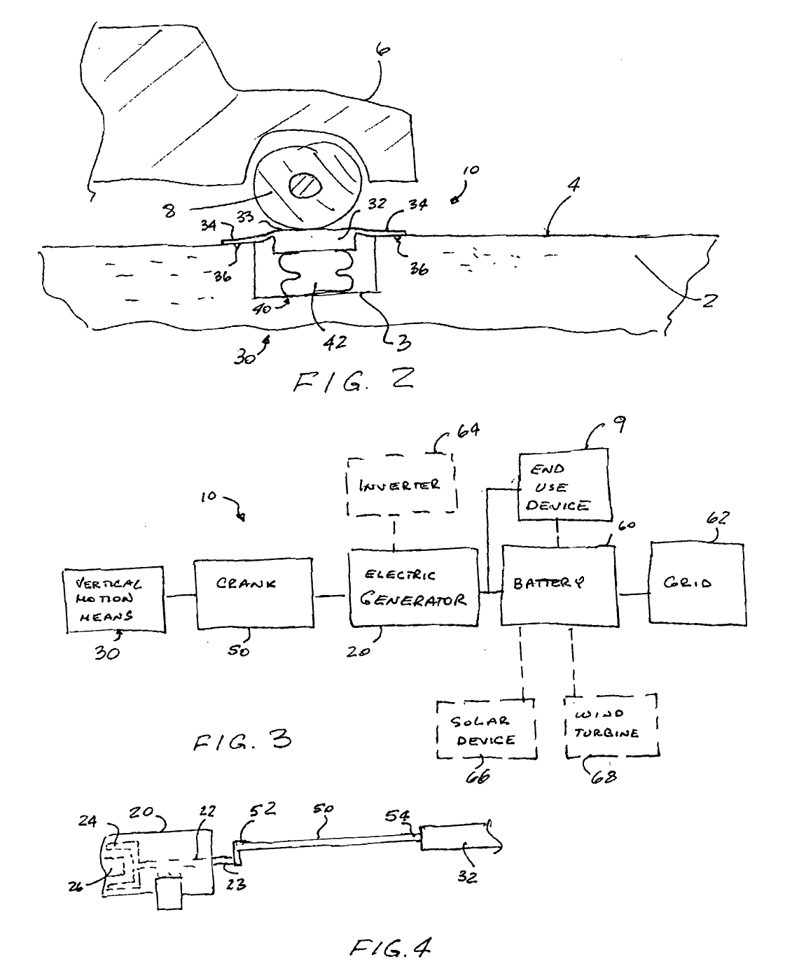

By way of the example only of FIG. 2, the elongated member 32 of a rigid construction and the at least one air spring actuator 42 may be positioned within the channel 3 formed within the roadway 2. Furthermore, a pair of flexible side edges 34 may be provided and secured to the roadway surface 4 with spikes 36 embedded into the surface 4 similar to mounting of traffic volume measuring devices or lane reflectors (not shown). It will be appreciated that the side edges 34 will seal the channel 3 from debris and weather elements.

The protrusion of the upper surface 33 of the elongated member 32 above the roadway surface 4 is determined to allow smooth motion of the vehicles wheels 8 while providing the vertical linear motion sufficient to operate the crank means 50. Likewise, the air spring actuators 42 are selected to enable such vertical motion of the elongated member 32 and withstand the weight of motor vehicles 8 traveling on the roadway surface 4.

The present invention contemplates to hide the electric generator 20 from direct view by preferably positioning it in a chamber 5 formed adjacent the roadway 2 and accessible through a cover panel 7 for inspection or maintenance purposes. If the electric generator 20 is to be mounted above the ground surface in the enclosure (not shown), it will be relatively simple to position such enclosure in close proximity to the roadway 2 so as not to obstruct the view of the natural surroundings.

The system, 10 can be employed in a variety of applications. Simple construction and simple complexity of the system 10 of the present invention provides an advantage over existing electric power generating system by enabling the use of such system 10 for operating dedicated and stand-alone devices. For example, as shown in FIG. 1, the system 10 can be employed for operating at least one light assembly 9 positioned alongside the roadway 2 and electrically coupled to the electric generator 20. It will be readily apparent to those skilled in the art that the system 10 also overcomes various disadvantages of the prior art electric power generating system and, more particularly, wind turbines by being generally hidden from direct view and muffling the noise generated by the electric generator 20 by positioning it within the ground. It also must be noted that any noise from the electric generator 20 positioned above the ground surface will be easily muffled by the noise from motor vehicles 6.

The system 10 of the present invention is also advantageous for use in calming traffic as what is conventionally known as a road-traffic speed control device or a speed bump. In such application, the vertical movement means 40, such as the air spring 42 will be selected to provide sufficient resistance to a motor vehicle 6 traveling at high speeds while enabling the downward movement of the elongated member 32 when the motor vehicle is traveling at low speeds, thus increasing the duration of the engagement between the wheels 8 and the upper surface 33.

It is within the scope of the present invention to store the electric power generated by the electric generator 20 and, accordingly, the system 10 includes a storage means, for example such as at least one battery 60. Thus, the at least one battery 60 will be capable of regulating the supply of generated electric power to various devices to insure uninterrupted operation thereof.

The electric power generated by the electric generator 20 may be delivered to a power grid 62 either directly or through the at least one battery 60.

It would be understood that a plurality of systems 10 can be connected to the at least one battery 60 or a power grid 62 in order to increase the electric power available for consumption.

Since, the electric generator 20 generally generates alternative current (AC) electric power, the system 10 may include a power conversion means operably coupled to the electric generator 20 for converting the electric power generated thereby. For example, such power conversion means may be a conventional inverter 64 capable of outputting direct current (DC) electric power.

It is also within the scope of the present invention to augment operation of the system 10 with solar type device 66 and/or wind electric power generating device 68 in applications wherein the use of such devices is permitted.

Although, the present invention has been illustrated in terms of using the elongated member 32 positioned across the roadway surface 4, it will be apparent to those skilled in the art that at least a pair of such members may be located in the portions of the roadway surface 4 generally engageable by the wheels 8.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A system for generating electric power, said system comprising:
(a) an electric generator capable of generating an electric power upon supply of a rotational motion;
(b) means mounted within a motor vehicle roadway for generating a linear motion in a vertical direction; and
(c) crank means having a first end thereof secured to a protruding end of an input shaft of said electric generator and having an opposed second end thereof operably connected to said vertical motion generating means for converting said vertical motion into said rotational motion.

2. The system, according to claim 1, wherein said vertical motion generating means include:
(a) an elongated member extending across at least a portion of a roadway surface, said elongated member engageable with wheels of vehicles traveling on such roadway surface, whereby said second end of said crank means is connected to said elongated member; and
(b) means disposed below the roadway surface and operably secured to said elongated member for enabling linear downward movement thereof in a vertical direction upon force applied by the motor vehicle wheels engaging an upper surface of said elongated member and for vertically returning said elongated member to an original position upon disengagement of the motor vehicle wheels with said upper surface thereof.

3. The system, according to claim 2, wherein said upper surface of said elongated member is positioned above the roadway surface in said original position.

4. The system, according to claim 2, wherein said vertical movement means includes at least one air spring actuator.

5. The system, according to claim 2, wherein said elongated member includes a pair of side edges and means for securing each side edge to the roadway surface.

6. The system, according to claim 1, wherein said system includes a storage means connected to said electric generator for storing said electric power generated thereby.

7. The system, according to claim 6, wherein said storage means is at least one battery.

8. The system, according to claim 6, wherein said system further includes a power grid connected to said storage means.

9. The system, according to claim 1, wherein said system includes a power conversion means operably coupled to said electric generator for converting said electric power generated thereby.

10. A method of generating electric power, said method comprising the steps of:
(a) providing means capable of generating reciprocal linear motion;
(b) mounting said linear motion generating means below a roadway surface having motor vehicles traveling thereon so that said linear motion is generated in a vertical direction;
(c) positioning an elongated member across at least a portion of said roadway surface;
(d) securing said elongated member to at least said linear motion generating means;
(e) positioning an electric generator in close proximity to said elongated member, said electric generator capable of generating an electric power upon supply of a rotational motion;
(f) connecting, with a crank mechanism, said elongated member to said electric generator;
(g) generating, with said crank mechanism, said rotational motion upon cyclical engagement and disengagement of motor vehicle wheels with said elongated member; and
(h) generating, with said electric generator, said electric power upon supply of said rotational motion.

11. The method, according to claim 10, wherein the step of positioning said elongated member across said at least portion of said roadway surface includes the step of positioning an upper surface of said elongated member above said roadway surface.

12. The method, according to claim 10, wherein said method includes the additional step of securing said elongated member to said roadway surface.

13. A road-traffic speed control apparatus which is positioned within a roadway, said apparatus comprising:
(a) an elongated member extending across at least a portion of a roadway surface, said elongated member having an upper surface thereof positioned above such roadway surface, said upper surface engageable with wheels of vehicles using such roadway; and
(b) means disposed below the roadway surface and operably secured to said elongated member for enabling linear downward movement thereof in a vertical direction upon force applied by the motor vehicle wheels engaging said upper surface of said elongated member and for vertically returning said elongated member to an original position upon disengagement of the motor vehicle wheels with said upper surface thereof.
